(19) United States
(12) Patent Application Publication
(10) Pub. No.: US 2005/0268742 A1
(43) Pub. Date: Dec. 8, 2005

(54) Wheeled vehicle with handlebar

(76) Inventor: Munetaka Koike, Shizuoka-ken (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/142,842

(22) Filed: Jun. 1, 2005

(30) Foreign Application Priority Data
Jun. 1, 2004 (JP) 2004-163414

(51) Int. Cl. B62K 1/00

(52) U.S. Cl. 74/551.1

(57) ABSTRACT

A wheeled vehicle includes a body frame. At least one wheel can contact with the ground. A coupling device rotatably couples the wheel with the body frame. A handlebar extends from a portion of the coupling device. At least a portion of the handlebar located adjacent to the portion of the coupling device has a first geometrical moment of inertia and a second geometrical moment of inertia. The first geometrical moment of inertia is defined about a first neutral axis that extends generally parallel to an impact load transferring axis along which an impact load from the ground transfers to the handlebar. The second geometrical moment of inertia is defined about a second neutral axis that intersects the first neutral axis generally at right angles. The second geometrical moment of inertia is smaller than the first geometrical moment of inertia.

### PRIORITY INFORMATION

This application is based on and claims priority to Japanese Patent Application No. 2004-163414, filed Jun. 1, 2004, the entire contents of which is hereby expressly incorporated by reference.

### BACKGROUND OF THE INVENTION

1. Field of the Invention

The present invention generally relates to a wheeled vehicle with a handlebar, and more particularly relates to a wheeled vehicle having a handlebar with which a rider operates the vehicle.

2. Description of Related Art

Wheeled vehicles such as, for example, motorcycles have a plurality of wheels rotatably coupled with a body frame. Typically, the motorcycles have front and rear wheels. Front and rear suspension units typically suspend the front and rear wheels, respectively, from the body frame. A prime mover, such as, for example, an engine, powers the rear wheel. The front wheel is steerable by the rider.

The front suspension unit includes a front fork that has a pair of fork members. The fork members interpose the front wheel therebetween and journal an axle of the front wheel. Each fork member usually includes upper and lower sections that are telescopically movable relative to each other to absorb impact loads from the ground. That is, the respective fork members usually incorporate a shock absorbing mechanism therein. Additionally, the front fork is steerably coupled with the body frame.

In a typical motorcycle, a handlebar extends generally horizontally and transversely from an upper portion of the front fork. Each end of the handlebar has a grip portion. Control devices such as, for example, a throttle grip and brake levers are furnished on the grip portions. The rider of the motorcycle thus can hold the grip portions to steer the motorcycle and controls the engine and rotations of the wheels using the throttle grip and the brake levers.

For example, Japanese Utility Model Publication No. 6-30682 discloses a handlebar for a motorcycle. A grip portion of the handlebar has an outer surface defining a circular shape and an inner surface defining an elliptic shape in cross-section. The handlebar is attached to a front fork of the motorcycle so that a major axis of the elliptic shape extends along a line of the rider's arm.

The front wheel receives impact loads from the ground while traveling on a rough road. The loads can transfer to the handlebar through the front fork. Usually, the impact loads can be absorbed by the telescopic movement of the upper and lower sections of the respective fork members. The impact loads then have less impact on rider.

A motorcycle for motocross, however, can jump obstacles. A large impact load can affect the front wheel at a moment when the motorcycle lands and can transfer to the handlebar. The rider may significantly feel the impact load because the impact load is so large that the shock absorbing mechanism cannot absorb the entire load.

Also, bicycles have a similar structure to the motorcycles. However, the bicycles usually do not have such a shock absorbing mechanism. Thus, the handlebar of the bicycles can directly receive the impact load from the ground even though the impact load is not so large, and the rider can feel the shock

### SUMMARY OF THE INVENTION

A need therefore exists for an improved wheeled vehicle that can inhibit an impact load from transferring to the rider.

To address the need, an aspect of the present invention involves a wheeled vehicle comprising a body frame. At least one wheel is adapted to contact with the ground. A coupling device is arranged to rotatably couple the wheel with the body frame. A handlebar extends from a portion of the coupling device. At least a portion of the handlebar is located adjacent to the portion of the coupling device having a first geometrical moment of inertia and a second geometrical moment of inertia. The first geometrical moment of inertia is defined about a first neutral axis that extends generally parallel to an impact load transferring axis along which an impact load from the ground transfers to the handlebar. The second geometrical moment of inertia is defined about a second neutral axis that intersects the first neutral axis generally at right angles. The second geometrical moment of inertia is smaller than the first geometrical moment of inertia

In accordance with another aspect of the present invention, a wheeled vehicle comprises a frame body. At least one wheel is supported by a front portion of the frame body for movement along a first axis. A handlebar is coupled with the front portion of the frame body. At least a portion of the handlebar located adjacent to the front portion of the frame body has a first geometrical moment of inertia and a second geometrical moment of inertia. The first geometrical moment of inertia is defined about a first neutral axis that extends generally parallel to the first axis. The second geometrical moment of inertia is defined about a second neutral axis that intersects the first neutral axis at right angles. The second geometrical moment of inertia is smaller than the first geometrical moment of inertia

### BRIEF DESCRIPTION OF THE DRAWINGS

These and other features, aspects and advantages of the present invention are now described with reference to the drawings of preferred embodiments, which are intended to illustrate and not to limit the present invention. The drawings comprise six figures in which:

FIG. 1 illustrates a side elevational view of a motorcycle configured in accordance with a preferred embodiment of the present invention, wherein a rider in a riding position is also shown;

FIG. 2 illustrates a top plan view of a handlebar of the motorcycle of FIG. 1;

FIG. 3 illustrates a rear elevational view of the handlebar of FIG. 2;

FIG. 4 illustrates a side elevational view of a top portion of a front fork of the motorcycle, wherein the handlebar is shown in cross-section;

FIG. 5 illustrates a cross-sectional view of another handlebar modified in accordance with another embodiment of the present invention; and

FIG. 6 illustrates a cross-sectional view of a further handlebar modified in accordance with an additional embodiment of the present invention.

### DETAILED DESCRIPTION OF PREFERRED EMBODIMENTS OF THE PRESENT INVENTION

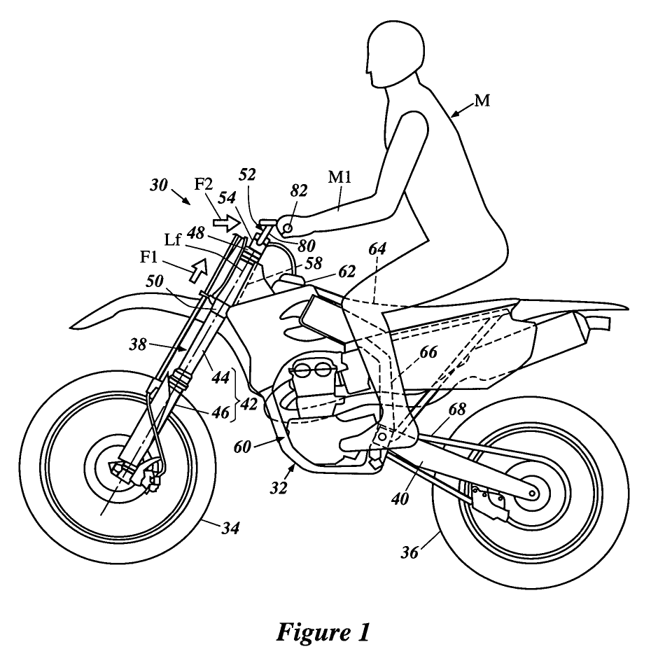

With particular reference to FIG. 1, an outline of a motorcycle 30 configured in accordance with certain features, aspects and advantages of the present invention is described.

The illustrated motorcycle 30 is an off-road type and is particularly suitable for motocross. The motocross is a cross-country race for relatively lightweight motorcycles. Handlebars described below are applied to the motorcycle 30. The motorcycle 30, however, merely exemplifies one type of a wheeled vehicle. The handlebars can be applied to other types of motorcycles, and also can be applied to other wheeled vehicles such as, for example, motor scooters, mopeds, ATVs (all terrain vehicles) and bicycles. Such applications will be apparent to those of ordinary skill in the art in light of the description herein.

FIG. 1 shows that a motocross rider M is in a riding position on the motorcycle 30. The motorcycle 30 of FIG. 1 has jumped in the air at a moment immediately before and is going to land.

The motorcycle 30 comprises a body frame 32 and wheels 34, 36. As used through this description, the terms “forward” and “front” mean at or to the side where the wheel 34 is positioned, and the terms “rear” and “rearward” mean at or to the opposite side of the front side, unless indicated otherwise or otherwise readily apparent from the context use. That is, the wheel 34 is a front wheel and the wheel 36 is a rear wheel.

Also, as used in this description, the term “horizontally” means that the subject portions, members or components extend generally parallel to the ground when the motorcycle 30 stands normally on the ground. The term “vertically” means that portions, members or components extend generally normal to those that extend horizontally.

Further, as used through the description, the term “right hand side” means the side where the right hand of the rider M is positioned, and the term “left hand side” means the side where the left hand of the rider M is positioned.

The motorcycle 30 further comprises a front suspension unit and a rear suspension unit. In the illustrated embodiment, the front suspension unit is a front fork 38, and the rear suspension unit includes a rear arm 40. Also, the front fork 38 is a coupling device that couples the front wheel 34 with the body frame 32 in this embodiment.

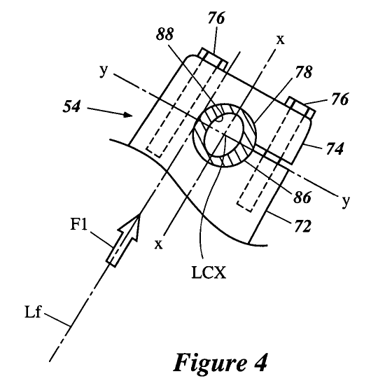

The front fork 38 preferably includes a pair of fork members 42 transversely spaced apart from each other and extend parallel to each other. Each fork member 52 comprises an upper section 44 and a lower section 46. Preferably, the upper and lower sections 44, 46 are cylindrically shaped and telescopically coupled with each other. In the illustrated embodiment, a lower part of the upper section 44 is inserted into the lower section 46 for axial movement along a fork member axis relative to the lower section 46. The fork member axes of the respective fork members 42 overlap with each other in view of FIGS. 1 and 4. Also, an impact load which the front wheel 34 receives from the ground transfers to a handlebar 52 from the fork members 42 along the fork member axes. Thus, the axis Lf of FIGS. 1 and 4 conveniently represents both of the fork member axes and is called as “impact load transferring axis” in this description. The illustrated upper and lower sections 44, 46 together incorporate a conventional shock absorbing mechanism or damping mechanism to absorb the impact load from the ground.

Preferably, an upper bracket 48 connects top ends of the respective upper sections 44, while a lower bracket 50 connects middle portions of the respective upper sections 44. The handlebar 52 extends generally horizontally and transversely above the upper bracket 48. A pair of handle crowns 54 are affixed to the upper bracket 48 to hold the handlebar 52. The respective lower sections 46 interpose the front wheel 34 therebetween and journal an axle of the front wheel 34 for rotation.

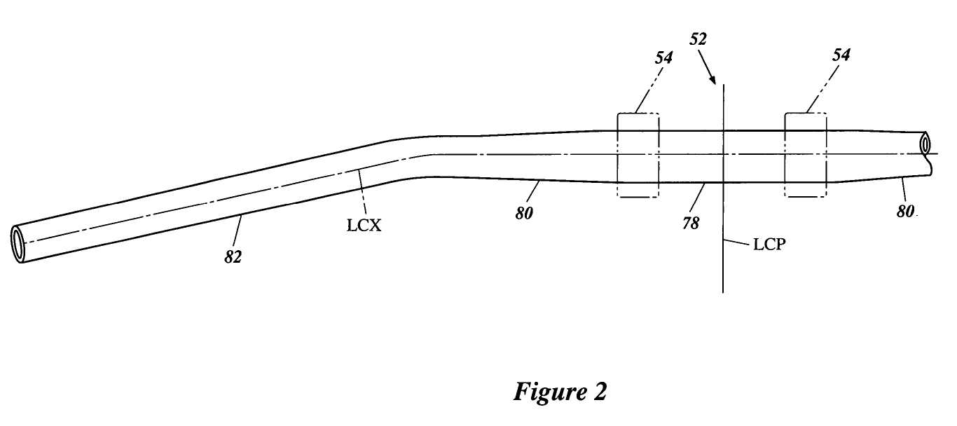

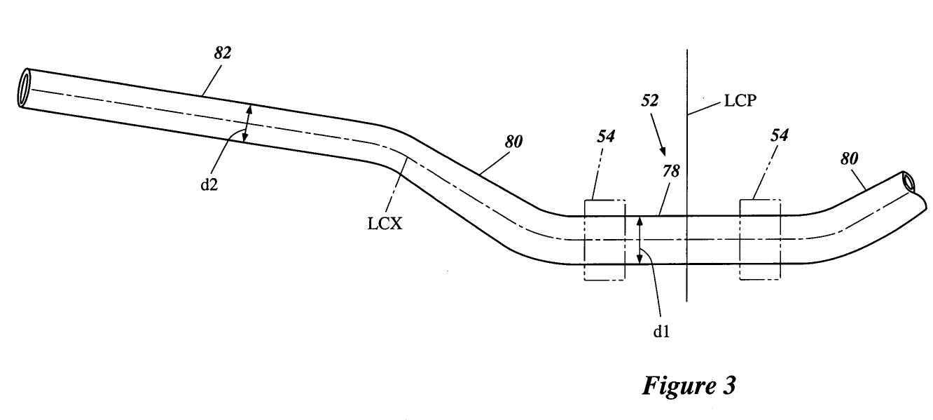

A steering shaft preferably extends parallel to the upper sections 44. The steering shaft is generally positioned between the respective upper sections 44 and generally equally spaced apart from the upper sections 44. Preferably, the steering shaft extends on and along a hypothetical longitudinal center plane LCP (FIGS. 2 and 3) of the motorcycle 30 that extends vertically and fore to aft. The body frame 32 has a head pipe 58 preferably at the most forward portion thereof. The head pipe 58 supports the steering shaft for pivotal movement about a steering axis. The rider M thus can steer the motorcycle 30 by operating the handlebar 52. The steering axis is positioned on the longitudinal center plane LCP and extends generally parallel to the impact load transferring axis (or fork member axes) Lf. In the illustrated embodiment, the steering axis generally overlaps with the impact load transferring axis Lf in view of FIGS. 1 and 4.

A prime mover is preferably mounted on a mid portion of the body frame 32. In the illustrated embodiment, an internal combustion engine 60 is used as the prime mover. A fuel tank 62 and a seat 64 are also mounted on the body frame 32 generally above the engine 60.

The rear arm 40 is pivotally affixed to a rear portion of the body frame 32. More specifically, a forward end of the rear arm 40 preferably has a pivot shaft that is affixed to a rear arm bracket 66 of the body frame 32. Bifurcated rear ends of the rear arm 40 preferably interpose the rear wheel 36 therebetween and journal an axle of the rear wheel 36 for rotation. The engine 60 powers the rear wheel 36 via a proper transmission. A drive chain 68 couples the transmission and the rear wheel 36 with each other for driving the rear wheel 36.

With reference to FIGS. 1-4, the handlebar 52 is described in greater detail below.

As best shown in FIG. 4, each handle crown 54 preferably comprises a base portion 72 and a cap portion 74. The base portion 72 is affixed to a top of the upper bracket 48. The cap portion 74 is detachably affixed to the base portion 72 by bolts 76 interposing the handlebar 52 therebetween.

The handlebar 52 is preferably tubular and is made of a cylindrical pipe. As shown in FIGS. 2 and 3, a hypothetical longitudinal center axis LCX of the handlebar 52 extends generally normal to the longitudinal center plane LCP at least between the handle crowns 54 and extends through the entire part of the handlebar 52. As shown in FIG. 4, in the illustrated embodiment, the longitudinal center axis LCX is positioned slightly to the rear of the impact load transferring axis (or fork member axes) Lf and is spaced apart approximately a radius of the handlebar 52 from the impact load transferring axis Lf FIGS. 2 and 3 show part of the handlebar 52 on the left hand side. The part on the left hand side represents the remainder part on the right hand side, because the illustrated handlebar 52 is generally symmetrically configured relative to the longitudinal center plane LCP. Preferably, the handlebar 52 comprises three sections, i.e., a horizontal section 78, rising sections 80 and end sections 82.

The horizontal section 78 preferably is a center region of the handlebar 52 and intersects the longitudinal center plane LCP. In the illustrated embodiment, as best shown in FIG. 3, the rising sections 80 inclines toward the respective and section 82 upward from the respective horizontal section 78. The end sections 82 further extend linearly outward from the respective rising sections 80. Although the end sections 82 still slant upward towards their respective outer end, the slant angles thereof are gentler than those of the rising sections 80.

The end sections 82 define grip portions where a handle grip and a throttle grip are attached. In the illustrated embodiment, the handle grip is fixedly attached to the end section 82 on the left hand side, while the throttle grip is rotatably attached to the end portion 82 on the right hand side. The throttle grip is connected to a throttle valve in the engine. The rider thus can control an output of the engine by operating the throttle grip. Additionally, brake levers are affixed to the end sections 82 to extend adjacent to the handle grip and the throttle grips. The rider controls the brake levers to operate a brake system of the motorcycle 30. As shown in FIG. 1, lower arms M1 of the rider M generally extend horizontally when the rider M grasps the grips.

The horizontal section 78 and the rising sections 80 generally extend normal to the longitudinal center plane LCP. As shown in FIG. 2, however, those sections 78, 80 extend slightly rearward and outward.

As shown in FIG. 3, an outer diameter d1 of the horizontal section 78 is preferably greater than an outer diameter d2 of the end sections 82. The rising sections 80 are preferably tapered to the end portions 82 from the horizontal sections 78. In other words, an outer diameter of each rising section 80 gradually becomes smaller to the end portion 82 from the horizontal section 78.

This configuration is advantageous because a bending stress caused by a bending moment exerted on the handlebar 52 can be generally uniformed along the length of the handlebar 52. This is because the bending moment is the maximum at the horizontal section 78 and becomes smaller toward the distal ends of the end portions 82.

With reference to FIGS. 1 and 4, a large impact load can be exerted on the front wheel 34 at a moment when the motorcycle 30 lands. Part of the impact load, which is indicated by reference symbol F1 of FIGS. 1 and 4, transfers to the front fork 38 and further to the handlebar 52 along the impact load transferring axis Lf. The impact load F1 can be principally absorbed by the telescopic movement of the upper and lower sections 44, 46 of the front fork 38 in this embodiment. However, the impact load F1 can still affect the handlebar 52. Additionally, if the front fork 38 has no damping structure, the impact load F1 can directly affect the handlebar 52 without attenuation.

In the illustrated embodiment, an outer surface 86 of the handlebar 52 defines a circular shape in a cross-section taken along a hypothetical vertical plane that includes an axis x-x and another axis y-y shown in FIG. 4. The axes x-x, y-y intersect at right angles with each other. The axes x-x, y-y also intersect the longitudinal center axis LCX of the handlebar 52 at right angles. An inner surface 88 of the handlebar 52 defines an elliptic shape in the same vertical plane. The axis x-x extends generally parallel to the impact load transferring axis Lf, while the axis y-y intersects the axis x-x and the impact load transferring axis Lf. A major axis of the elliptic shape is generally coincident with the axis x-x. In the illustrated embodiment, the major axis generally extends parallel to respective axes of the bolts 76. Also, a minor axis of the elliptic shape is generally coincident with the axis y-y and extends generally normal to the axes of the bolts 76. Preferably, the handlebar has this configuration at least in the horizontal section 78 and the rising sections 80, and more preferably, this configuration continues along the full length of the handlebar 52.

As thus configured and arranged, a first-geometrical (or area) moment of inertia is defined about the axis x-x, which is a neutral axis of the first geometrical moment of inertia. Also, a second geometrical moment of inertia is defined about the axis y-y, which is a neutral axis of the second geometrical (or area) moment of inertia, and the second geometrical moment of inertia is smaller than the first geometrical moment of inertia. In other words, the rigidity of the handlebar 52 in the direction along the axis x-x is lower than the rigidity of the handlebar 52 in the direction along the axis y-y. That is, the rigidity of the handlebar 52 is purposely reduced against the impact load F1 that is exerted along the impact load transferring axis Lf The handlebar 52 thus, comparatively can be elastically deformed more easily by the impact load F1 to effectively absorb more of the impact load F1. As a result, the impact load F1 is inhibited from transferring to the lower arm M1 of the rider M.

In addition, as discussed above, the end sections 82 are narrower than the horizontal section 78 in the illustrated embodiment. Because of this construction, the end sections 82 can more easily flex than the horizontal section 78. The impact load F1 thus can is more effectively relieved.

The rigidity of the handlebar 52 in the direction along the axis x-x is lower than the rigidity of the handlebar 52 in the direction along the axis y-y, as discussed above. In other words, the rigidity of the handlebar 52 in the direction along the axis y-y is higher than the rigidity of the handlebar 52 in the direction along the axis x-x. This is also advantageous because the handlebar 52 can be sufficiently rigid against a load F2 (FIG. 1) that is exerted on the handlebar 52 in the direction generally along the axis y-y. The load F2 can be produced by a bending moment affecting the handlebar 52, for example, when the motorcycle 30 falls on the ground.

In addition, the bending moment can be the maximum at the horizontal section 78. In the illustrated embodiment, the horizontal section 78 has the largest diameter. Thus, the illustrated handlebar 52 is much stronger against the load F2.

In one variation, the outer surface can be an elliptic shape, while the inner surface can be a circular shape. The major axis of the elliptic shape extends along the axis y-y, and the minor axis of the elliptic shape extends along the axis x-x in this variation.

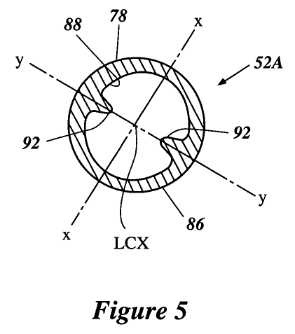

With reference to FIG. 5, another handlebar 52A modified in accordance with another embodiment of the present invention is described below. The same member or portions as those which have been already described are assigned with the same reference numerals or symbols and are not repeatedly described.

In this embodiment, the handlebar 52A preferably has a pair of inner projections or ribs 92 extending on and along the axis y-y toward an intersectional point of the axes x-x, y-y, i.e., the longitudinal center axis LCX of the handlebar 52A. The projections 92 are opposed to each other. Each inner projection 92 is a projected strake or wall transversely extending along the longitudinal center axis LCX. The inner projections 92 can extend either continuously or discontinuously. Preferably, each inner projection 92 runs in the horizontal section 78. More preferably, each inner projection 92 runs in the horizontal section 78 and the rising sections 80 or further the full length of the handlebar 52A. The outer surface 86 preferably has a circular shape. The inner surface 88 can take either the elliptic shape that is similar to the shape of FIG. 4 or a circular shape. In this embodiment, the inner surface 88 is the elliptic shape.

The geometrical (or area) moment of inertia, which neutral axis is the axis x-x, becomes larger because of the inner projections 92 in the illustrated embodiment. In other words, the geometrical moment of inertia, which neutral axis is the axis y-y, becomes smaller.

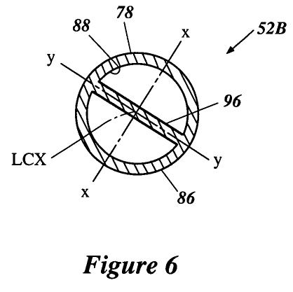

With reference to FIG. 6, a further handlebar 52B modified in accordance with additional embodiment of the present invention is described below. The same member or portions as those which have been already described are assigned with the same reference numerals or symbols and are not repeatedly described.

In this embodiment, the handlebar 52B preferably has an inner bridge or transverse member 96 extending on and along the axis y-y. The inner bridge 96 is a wall transversely extending along the longitudinal center axis LCX. The inner bridge 96 can extend either continuously or discontinuously. Preferably, the inner bridge 96 runs in the horizontal section 78. More preferably, the inner bridge 96 runs in the horizontal section 78 and the rising sections 80 or further the full length of the handlebar 52A. The outer surface 86 preferably has a circular shape. The inner surface 88 except for the bridge 96 can take either the elliptic shape that is similar to the shape of FIG. 4 or a circular shape. In this embodiment, the inner surface 88 is the circular shape.

Similarly to the second embodiment described above, the geometrical (or area) moment of inertia, which neutral axis is the axis x-x, becomes larger because of the inner bridge 96 in this embodiment. In other words, the geometrical (or area) moment of inertia, which neutral axis is the axis y-y, becomes smaller.

A wheeled vehicle in the present invention can employ various coupling devices other than the front fork 38. The coupling device does not necessarily have a shock absorbing function or a damping function. In other words, the coupling device can be a rigid coupling. For example, the front wheel 34 is not necessarily axially movable relative to the body frame 32. Also, an ordinary type of bicycle does not have a front wheel that axially moves relative to its body frame but has a front wheel rigidly affixed to the body frame and is only allowed to rotate and be steered. It should be noted that even such a wheeled vehicle can take advantage of the present invention

Also, a construction like the rear suspension unit can be used. More specifically, the body frame can support a front arm like the rear arm for pivotal movement about a horizontal axis at a location adjacent to the engine. The front arm can be coupled with the body frame via a damper. A forward end of the front arm can hold the front wheel. The front wheel thus can pivotally move relative to the body frame. The axis x-x of the handlebar would extend generally parallel to an arc which is a locus of the axle of the front wheel in this alternative construction.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while several variations of the invention have been shown and described, other modifications, which are within the scope of this invention, will be readily apparent to those of skill in the art based upon this disclosure. It is also contemplated that various combination or sub-combinations of the specific features and aspects of the embodiments or variations may be made and still fall within the scope of the invention. It should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims.

1. A wheeled vehicle comprising a body frame, at least one wheel adapted to contact with the ground, a coupling device arranged to rotatably couple the wheel with the body frame, and a handlebar extending from a portion of the coupling device, at least a portion of the handlebar located adjacent to the portion of the coupling device having a first geometrical moment of inertia and a second geometrical moment of inertia, the first geometrical moment of inertia being defined about a first neutral axis that extends generally parallel to an impact load transferring axis along which an impact load from the ground transfers to the handlebar, the second geometrical moment of inertia being defined about a second neutral axis that intersects the first neutral axis generally at right angles, and the second geometrical moment of inertia being smaller than the first geometrical moment of inertia.

2. The wheeled vehicle as set forth in claim 1, wherein the handlebar comprises first and second sections, the first section extends from the coupling device and extends generally horizontally, the second section extends from the first section, and said portion of the handlebar at least includes the first section.

3. The wheeled vehicle as set forth in claim 2, wherein the handlebar further comprises a third section that extends from the second section, and an outer diameter of the first section is greater than an outer diameter of the third section.

4. The wheeled vehicle as set forth in claim 3, wherein a cross-section of the second section is tapered toward the third section from the first section.

5. The wheeled vehicle as set forth in claim 1, wherein the handlebar includes a second portion having a cross-section that tapers in size in a direction away for the first section.

6. The wheeled vehicle as set forth in claim 1, wherein the handlebar is tubular, an outer surface of the handlebar defines a substantially circular shape in a cross-section taken along a vertical plane including the first and second neutral axes, an inner surface of the handlebar defines a substantially elliptic shape in the same cross-section, and a major axis of the elliptic shape is generally coincident with the first neutral axis, and a minor axis of the elliptic shape is generally coincident with the second neutral axis.

7. The wheeled vehicle as set forth in claim 1, wherein the handlebar is tubular, and the handlebar has an inner projection generally protruding in a direction along the second neutral axis.

8. The wheeled vehicle as set forth in claim 1, wherein the handlebar is tubular, the handlebar has a pair of inner projections that generally protrude along portions of the second neutral axis, and the inner projections are opposed to each other.

9. The wheeled vehicle as set forth in claim 1, wherein the handlebar is tubular, the handlebar has an inner bridge connecting together two portions of an inner surface of the handlebar, and the inner bridge generally extends along the second neutral axis.

10. The wheeled vehicle as set forth in claim 1, wherein the wheel is movable relative to the body frame generally along the impact load transferring axis.

11. The wheeled vehicle as set forth in claim 10, wherein the coupling device comprises upper and lower sections telescopically movable with respect to each other at least generally along the impact load transferring axis, the handlebar extends from the upper sections, and the lower section carries the wheel.

12. The wheeled vehicle as set forth in claim 11, wherein the coupling device is a front fork that has a pair of fork members, each fork member has the upper and lower sections, and the lower sections interpose the wheel therebetween.

13. A wheeled vehicle comprising a frame body, at least one wheel supported by a front portion of the frame body for movement along a first axis, a handlebar coupled with the front portion of the frame body, at least a portion of the handlebar located adjacent to the front portion of the frame body having a first geometrical moment of inertia and a second geometrical moment of inertia, the first geometrical moment of inertia being defined about a first neutral axis that extends generally parallel to the first axis, the second geometrical moment of inertia being defined about a second neutral axis that intersects the first neutral axis at right angles, and the second geometrical moment of inertia being smaller than the first geometrical moment of inertia.

14. The wheeled vehicle as set forth in claim 13, wherein the handlebar has a second portion that is tapered outwardly.

15. The wheeled vehicle as set forth in claim 13, wherein the handlebar is tubular, an outer surface of the handlebar defines a substantially circular shape in a cross-section taken along a vertical plane including the first and second neutral axes, an inner surface of the handlebar defines a substantially elliptic shape in the same cross-section, a major axis of the elliptic shape is generally coaxial with the first neutral axis, and a minor axis of the elliptic shape is generally coaxial with the second neutral axis.

16. The wheeled vehicle as set forth in claim 13, wherein the handlebar is tubular, and the handlebar has an inner rib extending along the second neutral axis.

17. The wheeled vehicle as set forth in claim 13, wherein the handlebar is tubular, the handlebar has a transverse member that connects two portions of an inner surface of the handlebar with each other, and the transverse generally extends along the second neutral axis and intersects.
